(19) United States
(12) Patent Application Publication
(10) Pub. No.: US 2025/0350875 A1
(43) Pub. Date: Nov. 13, 2025

(54) UNIVERSAL FILM APPLICATION DEVICE FOR EARPHONE

(71) Applicant: SHENZHEN ABEE TECHNOLOGY CO.,LTD, SHENZHEN (CN)

(72) Inventor: QIANG XIONG, SHENZHEN (CN)

(21) Appl. No.: 19/203,629

(22) Filed: May 9, 2025

(30) Foreign Application Priority Data
May 10, 2024 (CN) 202421008590.8

(51) Int. Cl. H04R 1/10

(52) U.S. Cl. CPC H04R 1/1058; H04R 2460/17

(57) ABSTRACT

A universal film application device for an earphone includes a fixing plate and a limiting structure. Fitting pieces are disposed on the fixing plate. The limiting structure includes a buckling piece and a limiting groove. The buckling piece is capable of detachably connecting with any one of the fitting pieces. The limiting groove is disposed in one side of the limiting structure away from the fixing plate, and the limiting groove is configured to limit a first end of the earphone. One end of the fixing plate extends to define an abutting groove. The abutting groove is configured to abut against a second end of the earphone. The fixing plate further includes an extension rod disposed between the fitting pieces and the abutting groove. The extension rod is configured to fix a combined film composed of a release film, a decorative film, and a base film.

### CROSS-REFERENCE TO RELATED APPLICATION

The present disclosure claims foreign priority to Chinese Patent Application No. CN202421008590.8, titled FILM APPLICATION DEVICE FOR EARPHONE, filed on May 10, 2024 in the State Intellectual Property Office of China, and the entire contents of which is hereby incorporated by reference.

### TECHNICAL FIELD

The present disclosure relates to a technical field of earphones accessories, and in particular to a universal film application device for an earphone.

### BACKGROUND

An earphone film attaching device is a device that positions an in-ear earphone and then paste a film on the in-ear earphone. Since the in-ear earphone is relatively small, a shape of an in-ear portion thereof is irregular, and a handle thereof is thin, it is inconvenient to hold the in-ear earphone in the hand to paste the film.

Although there are earphone film attaching devices for different in-ear earphones on the market, a specific in-ear earphone is generally positioned in a groove of a specific earphone film attaching device that matches a shape of the specific in-ear earphone, and then the film is pasted on the specific in-ear earphone. However, the in-ear earphones vary in length and shape, and a specific fixing device of the specific earphone film attaching device is only allowed to fix the specific in-ear earphone of a specific size, and is unable to position and paste films to different in-ear earphones.

### SUMMARY

In view of this, the present disclosure provides a universal film application device for an earphone, which solves a problem of small application range of earphone film attaching devices in the prior art.

To achieve the above object, the present disclosure provides the universal film application device for the earphone. The universal film application device comprises a fixing plate and a limiting structure. Fitting pieces are disposed on the fixing plate. The limiting structure comprises a buckling piece and a limiting groove. The buckling piece is capable of detachably connecting with any one of the fitting pieces. The limiting groove is disposed in one side of the limiting structure away from the fixing plate, and the limiting groove is configured to limit a first end of the earphone. One end of the fixing plate extends to define an abutting groove. The abutting groove is configured to abut against a second end of the earphone. The fixing plate further comprises an extension rod. The extension rod is disposed between the fitting pieces and the abutting groove. The extension rod is configured to fix a combined film.

In one embodiment, the combined film comprises a release film, a decorative film, and a base film. The release film, the decorative film, and the base film are detachably connected. The release film is disposed on a first side of the decorative film. The base film is disposed on a second side of the decorative film, and the combined film is centrally positioned on the fixing plate.

In one embodiment, a bottom wall of the limiting groove is curved. The limiting groove is matched with the first end of the earphone. The first end of the earphone is an in-ear portion of the earphone.

In one embodiment, the abutting groove is a circular groove. A size of the abutting groove is matched with the second end of the earphone. The second end of the earphone is one end of a main body away from the in-ear portion of the earphone.

In one embodiment, the fitting pieces are accommodating holes. The buckling piece is a buckle. The buckle is capable of engaging with any one of the accommodating holes.

In one embodiment, the buckle comprises a fool-proof bump, and the fitting pieces are fool-proof holes matched with the fool-proof bump.

In one embodiment, the buckle is cross-shaped, the accommodating holes are cross-shaped to match with the buckle, and the accommodating holes are communicated with each other.

In one embodiment, the buckle is of an asymmetric structure.

In one embodiment, a through hole is defined in a bottom wall of the abutting groove, and the through hole allows an earphone line of the earphone to pass through.

In one embodiment, the fitting pieces are longitudinally disposed on the fixing plate, and a distance between any two adjacent fitting pieces is different from a distance between any other two adjacent fitting pieces.

In one embodiment, the fitting pieces comprise three fitting pieces, and two of the fitting pieces located in a middle of the fixing plate are close to each other.

In one embodiment, a distance between a center of a first fitting piece and a center of a second fitting piece is 1-3 mm. A distance between the center of the second fitting piece and a center of a third fitting piece is 5-12 mm.

In one embodiment, a length of any of two ends of a longitudinal section of the extension rod is greater than a length of a middle portion of the longitudinal section of the extension rod. The combined film is centrally positioned on the extension rod.

In one embodiment, a sticking groove is defined in the extension rod.

In one embodiment, an opening of the abutting groove faces the limiting structure, and an elastic rubber structure is disposed in the abutting groove.

In one embodiment, the elastic rubber structure is a rubber ring.

In one embodiment, an inner diameter of the rubber ring is 4.5-7 mm. A height of the rubber ring is 8-12 mm, and a thickness of the rubber ring is 2-5 mm.

In one embodiment, the fitting pieces comprise two fitting pieces.

In one embodiment, a distance between the two fitting pieces is 5-12 mm.

In one embodiment, a distance from a first fitting piece to an outermost edge of the abutting groove is 15-30 mm.

By using the universal film application device of the present disclosure, the first end of the earphone is fixed by the limiting groove, and the second end of the earphone is fixed by the rubber ring on the abutting groove. Since the buckling piece on the limiting structure is capable of detachably connecting with any one of the fitting pieces on the fixing plate, and the limiting structure is allowed to be removed from one of the fitting pieces on the fixing plate and is allowed to be installed on another one of the fitting pieces, thereby changing a distance between the limiting groove and the abutting groove. Therefore, the universal film application device is capable of matching with earphones of different lengths. When in use, the combined film is centered and positioned on the fixing plate. The decorative film with a pattern is separated from the base film, and the decorative film is pasted on the earphone.

### BRIEF DESCRIPTION OF DRAWINGS

In order to clearly describe technical solutions in the embodiments of the present disclosure, the following will briefly introduce the drawings that need to be used in the description of the embodiments or the prior art. Apparently, the drawings in the following description are merely some of the embodiments of the present disclosure, and those skilled in the art are able to obtain other drawings according to the drawings without contributing any inventive labor.

FIG. 1 is a perspective schematic diagram of a universal film application device for an earphone with a combined film being removed according to a first embodiment of the present disclosure.

FIG. 2 is another perspective schematic diagram of the universal film application device for the earphone with the combined film being removed according to the first embodiment of the present disclosure.

FIG. 3 is a perspective schematic diagram of the universal film application device for the earphone with a limiting structure being removed according to the first embodiment of the present disclosure.

FIG. 4 is a schematic diagram of the limiting structure according to the first embodiment of the present disclosure.

FIG. 5 is a schematic diagram of the combined film according to the first embodiment of the present disclosure.

FIG. 6 is a perspective schematic diagram of the universal film application device for the earphone with the combined film being removed according to a second embodiment of the present disclosure.

FIG. 7 is an exploded schematic diagram of the universal film application device for the earphone with the combined film being removed according to the second embodiment of the present disclosure.

FIG. 8 is another exploded schematic diagram of the universal film application device for the earphone with the combined film being removed according to the second embodiment of the present disclosure.

In the drawings:
1—fixing plate; 11—abutting groove; 111—rubber ring; 12—accommodating hole; 13—through hole; 14—extension rod; 141—sticking groove; 2—limiting structure; 21—buckle; 22—limiting groove; 3—combined film; 31—release film; 311—holding portion; 32—decorative film; 33—base film.

### DETAILED DESCRIPTION

Unless otherwise defined, all technical and scientific terms used herein have the same meaning as commonly understood by those skilled in the art of the present disclosure. The terminology used in the specification is for the purpose of describing specific embodiments only and is not intended to limit the present disclosure. Terms “have”, “include”, and any variations thereof in the specification and claims of the present disclosure are intended to cover non-exclusive inclusion, Terms “first”, “second”, and the like in the specification and claims of the present disclosure are used to distinguish different objects, and are not used to describe a specific order.

Reference herein to “embodiment” means that a particular feature, structure, or characteristic described in connection with one embodiment may be included in at least one embodiment of the present disclosure. The appearances of the “embodiment” in various positions in the specification are not necessarily referring to the same embodiment, and are not independent or alternative embodiments mutually exclusive of other embodiments. Those skilled in the art explicitly and implicitly understand that the embodiments described herein may be combined with other embodiments.

In order to enable those skilled in the art to better understand the solution of the present disclosure, the technical solutions in the embodiments of the present disclosure are clearly and completely described below in conjunction with the accompanying drawings.

### Embodiment 1

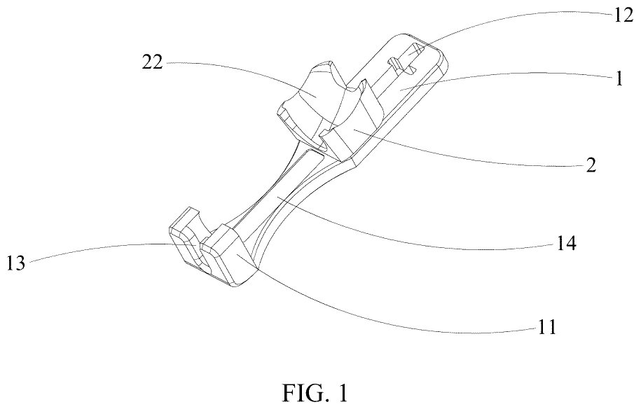

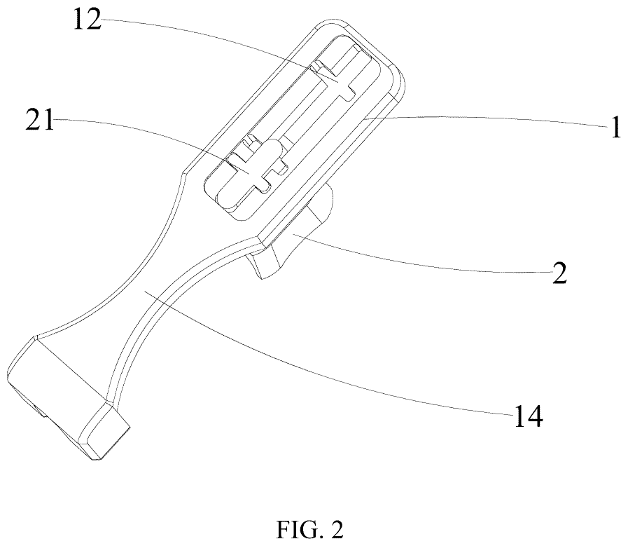

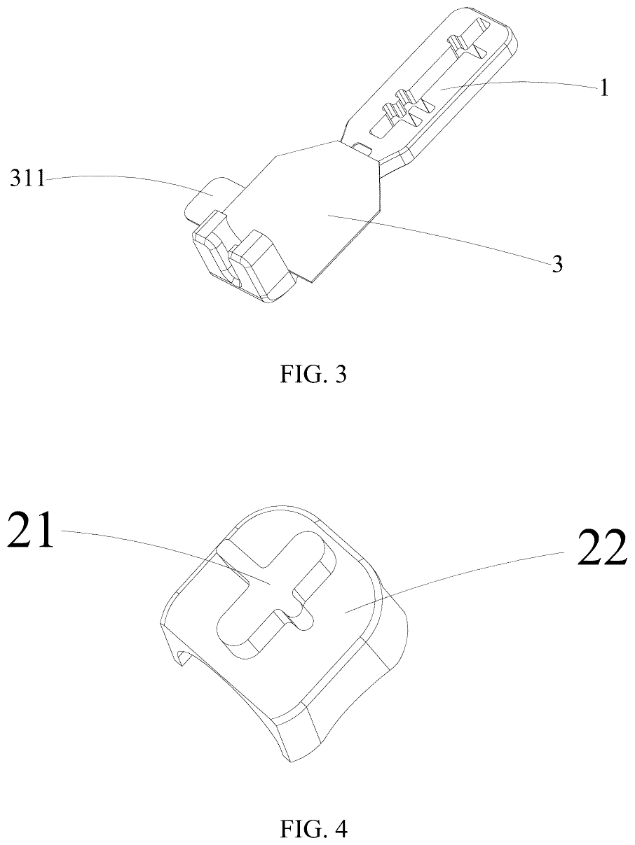

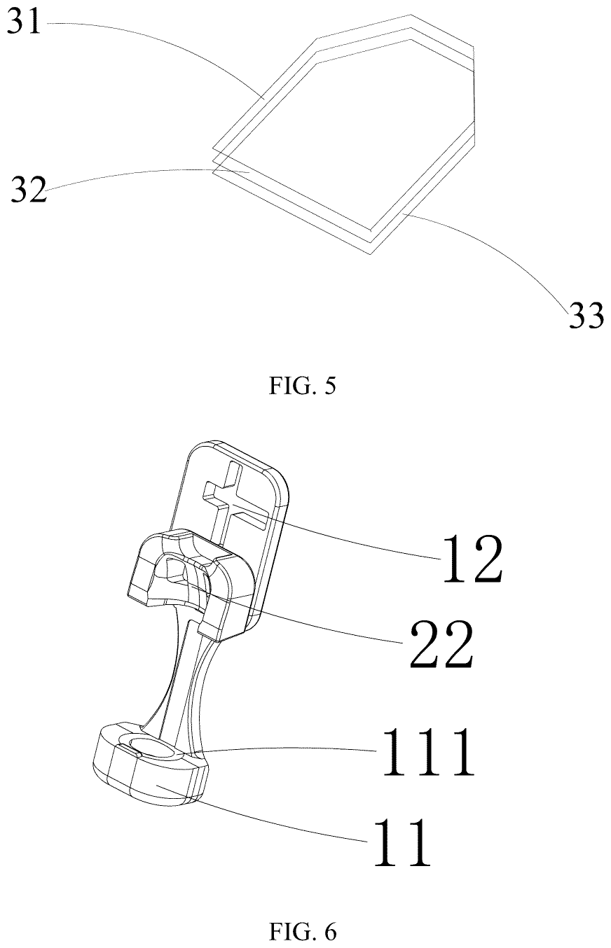

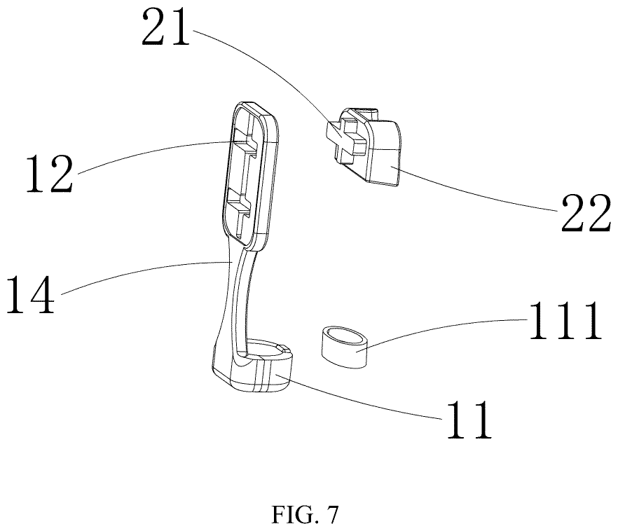

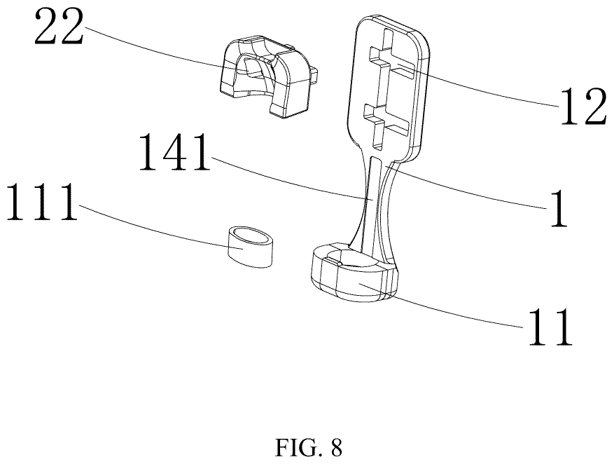

As shown in FIGS. 1-5, the present disclosure provides a universal film application device for an earphone. The universal film application device comprises a fixing plate 1, a limiting structure 2, and a combined film 3. Fitting pieces are disposed on the fixing plate 1. The limiting structure 2 comprises a buckling piece and a limiting groove 22. The buckling piece is capable of detachably connecting with any one of the fitting pieces. The limiting groove 22 is disposed in one side of the limiting structure 2 away from the fixing plate 1, and the limiting groove 22 is configured to limit a first end of the earphone. One end of the fixing plate 1 extends to define an abutting groove 11. The abutting groove 11 is configured to abut against a second end of the earphone. It is worth mentioning that the limiting groove is cleverly designed to be compatible with curved surfaces of different in-ear earphones on the market.

The combined film 3 comprises a release film 31, a decorative film 32, and a base film 33. The release film 31, the decorative film 32, and the base film 33 are detachably connected in sequence. The release film 31 is disposed on a first side of the decorative film 32. The base film 33 is disposed on a second side of the decorative film 32, and the combined film 3 is centrally positioned on the fixing plate 1.

A length of the combined film 3 is roughly the same as a length of a main body of the earphone body. The combined film 3 is limited by cooperation of the fixing plate 1 and the limiting structure 2. A first end of the combined film 3 abuts against a lower end of the fixing plate 1, and a second end abuts against a lower end of the limiting structure 2, so that the combined film 3 is centered and positioned on the fixing plate 1.

The earphone of the in-ear earphones comprises an in-ear portion and the main body supporting the in-ear portion. The in-ear earphones may be wired earphones and wireless earphones. After the earphone is fixed, the decorative film with a pattern is pasted on the main body to decorate the earphone.

Specifically, the fitting pieces are accommodating holes 12. The buckling piece is a buckle 21. The buckle 21 is capable of engaging with any one of the accommodating holes 12.

A shape of the buckle 21 is matched a shape of any one of the accommodating holes 12. When the buckle 21 is inserted into one of the accommodating holes 12, the buckle 21 is not easy to fall out of the one of the accommodating holes 12 without external force. After the buckle 21 is connected with the one of the accommodating holes 12, a position of the limiting structure 2 is limited relative to the fixing plate 1, and a distance between the limiting groove 22 and the abutting groove 11 is limited. When the in-ear portion of the earphone abuts against the limiting groove 22, and one end of the main body away from the in-ear portion abuts against the abutting groove 11, so a position of the earphone is fixed. Before fixing the earphone, the base film 33 is peeled off from the decorative film 32, and then the earphone is fixed by the cooperation of the fixing plate 1 and the limiting structure 2. After the decorative film 32 is stably attached to the earphone, the earphone is taken out, and the release film 31 is manually peeled off from the decorative film 32 to complete a film pasting process. In other embodiments, a holding portion 311 for easy separation of the release film is disposed on the release film 31 to further simplify the operation.

The accommodating holes 12 are longitudinally disposed on the fixing plate 1, and a distance between any one of the accommodating holes 12 to the abutting groove 11 is different from a distance between another one of the accommodating holes 12 to the abutting groove 11, so that the fixing plate 1 is matched with in-ear earphones of different longitudinal opening. When in use, the limiting structure 2 is removed from one of the accommodating holes 12 on the fixing plate 1 and then inserted into another one of the accommodating holes 12. The distance between the limiting groove 22 and the abutting groove 11 is changed, so that the fixing plate is adapted to the in-ear earphones of different lengths. The distance between any two adjacent fitting pieces is different. Since sizes of common in-ear earphones on the market are fixed, the fixing pieces is allowed to adapt to the earphone of the common in-ear earphones.

In other embodiments, a fixing hole is defined in the limiting structure 2, and corresponding fixing blocks are disposed on the fixing plate 1, so that the limiting structure 2 is detachably connected with the fixing plate 1.

In the embodiment, the abutting groove 11 is a circular groove. A size of the abutting groove 11 is matched with the second end of the earphone. The second end of the earphone is one end of the main body away from the in-ear portion of the earphone.

The second end of the earphone is inserted into the abutment groove 11, and the first end of the earphone is fitted with the limiting groove 22. A bottom wall of the limiting groove 22 is curved. That is, a thickness of the bottom wall gradually decreases from a first end thereof to a second end thereof. Since an outer surface of the in-ear portion of the earphone is a curved surface, the bottom wall of the limiting groove 22 fits with the outer surface of the in-ear portion. The in-ear portion is inserted into the limiting groove 22, and a side wall of the limiting groove 22 fixes the in-ear portion. The abutting groove 11 and the limiting groove 22 cooperate with each other to fix the position of the earphone.

In the embodiment, the buckle 21 is cross-shaped, the accommodating holes 12 are cross-shaped to match with the buckle 21, and the accommodating holes 12 are communicated with each other. The accommodating holes 12 are connected with form a longitudinal opening, and the longitudinal opening further defines holes extending in a horizontal direction. Since a size of the earphones is small, although the in-ear earphones of different models have different lengths, a difference in distance is not large. The accommodating holes 12 are communicated, so that each two adjacent accommodating holes 12 define an overlapping portion. Compared with configuring independent accommodating holes 12, the accommodating holes 12 communicated with each other not only adapt to the in-ear earphones of different models, but also allows the buckle 21 to be made larger, which is convenient for both removing and assembling of the buckle 21. For instance, a distance between a center of a first fitting piece and a center of a second fitting piece is 1-3 mm, such as 1.5 mm. A distance between the center of the second fitting piece and a center of a third fitting piece is 5-12 mm, such as 8.5 mm. A distance from the first fitting piece to an outermost edge of the abutting groove 11 is 15-30 mm, such as 21.27 mm.

In addition, the buckle 21 comprises a fool-proof bump, and the fitting pieces are fool-proof holes matched with the fool-proof bump. In the embodiment, the buckle 21 is of an asymmetric structure. Specifically, even the buckle 21 is cross-shaped, a length of a left side of the buckle 21 is different from a length of a right side of the buckle 21. Since the limiting structure 2 is not centrally symmetrical, the fool-proof bump prevents a user from inserting the limiting structure 2 in reverse when assembling the buckle on the fixing plate 1, thereby improving a user experience. In other embodiments, the buckle 21 may be configured to consist of a plurality of bumps, which are asymmetrically distributed, so as to achieve both fixation and fool-proof effects.

Moreover, a through hole 13 is defined in a bottom wall of the abutting groove 11, and the through hole allows an earphone line of the earphone to pass through. Therefore, no matter the earphone is belonged to the wired earphones or the wireless earphone, the earphone is relatively fixed by the fixing plate 1.

In the embodiment, the fixing plate 1 further comprises an extension rod 14. The extension rod 14 is disposed between the fitting pieces and the abutting groove 11. A length of any of two ends of a longitudinal section of the extension rod 14 is greater than a length of a middle portion of the longitudinal section of the extension rod 14.

When the decorative film 32 is applied to the earphone, the decorative film 32 is pasted together with the release film 31, and the decorative film 32 is a planar structure. The extension rod 14 defines a groove, and the combined film 3 is fixed in the groove. The combined film 3 is centered and positioned on the groove. When in use, the base film 33 is separated from the decorative film 32 first, and then the earphone is fixed, then left and right sides of the decorative film 32 are attached to the earphone, and a remaining part of the decorative film 32 is pasted firmly. The extension rod 14 may affect a pasting of the decorative film 32, so a width of the middle portion of the extension rod 14 is narrow. It is worth mentioning that the groove of the extension rod 14 is a sticking groove 141. The combined film 3 is first fixed by double-sided tape or the like in the sticking groove 141, and then the subsequent film pasting operation is performed.

### Embodiment 2

Referring to the first embodiment, in the second embodiment, in terms of an overall structure, except for structures of the abutting groove 11 and the number and positions of the fitting pieces, other structures are the same as that in the first embodiment, which are not described in detail herein. A difference between the first embodiment and the second embodiment is that in the second embodiment, an opening of the abutting groove 11 faces the limiting structure 2, and an elastic rubber structure is disposed in the abutting groove 11. In the embodiment, the elastic rubber structure is deformable and is a rubber pad or a rubber ring. Taking the rubber ring as an example, the rubber ring 111 may be a silicone ring, which has a certain deformation ability, and an inner diameter of the silicone ring is 4.5-7 mm, such as 5 mm or 6 mm. A height of the silicone ring is 8-12 mm, such as 10 mm or 8 mm. The height of the silicone ring is a distance between two ends of the silicone ring along a length direction of the fixing plate after the silicone ring is fixed.

In addition, two fitting pieces are provided, and structures of the two fitting pieces are the same as that in the first embodiment. A distance between the two fitting pieces is 5-12 mm, such as 9.5 mm. The rubber ring in the abutting groove 11 and the limiting groove 22 jointly limit the position of the earphone, so that the universal film application device is adapted to an ear hook of the in-ear earphones with different lengths. For example, taking the inner diameter of the silicone ring as 5 mm, the outer diameter as 7 mm, a thickness is 2 mm (that is, a difference between the inner diameter and the outer diameter), and the height as 10 mm, since the second end of the earphone is inserted into the silicone ring, and the silicone ring is able to be deformed, when the limiting structure 2 is inserted into the second fitting piece, the decorative film is pasted to the earphones having a length adapted to the length defined by the limiting structure and the second fitting piece in the same manner as the first embodiment. For another earphone that is no more than 10 mm longer than the earphone, the second end thereof is inserted into the silicone ring and an in-ear portion thereof is placed in the limiting groove 22 to be doubly fixed, and the film pasting operation is performed.

Obviously, the embodiments described above are only some embodiments of the present disclosure, rather than all embodiments. The optional embodiments of the present disclosure are given in the accompanying drawings, but they do not limit the protection scope of the present disclosure. The present disclosure can be implemented in many different forms. In addition, a purpose of providing these embodiments is to make the understanding of the disclosure of the present disclosure more thorough and comprehensive. Although the present disclosure is described in detail with reference to the embodiments described above, for those skilled in the art, it is still possible to modify the technical solutions recorded in the specific implementation methods, or to perform equivalent replacement of some of the technical features therein. Any equivalent structure made using the contents of the specification and drawings of the present disclosure, directly or indirectly used in other related technical fields, is within the protection scope of the present disclosure.

What is claimed is:

1. A universal film application device for an earphone, comprising:
a fixing plate; and
a limiting structure;
wherein fitting pieces are disposed on the fixing plate, the limiting structure comprises a buckling piece and a limiting groove, and the buckling piece is capable of detachably connecting with any one of the fitting pieces, the limiting groove is disposed in one side of the limiting structure away from the fixing plate, and the limiting groove is configured to limit a first end of the earphone;
wherein one end of the fixing plate extends to define an abutting groove, and the abutting groove is configured to abut against a second end of the earphone, the fixing plate further comprises an extension rod, the extension rod is disposed between the fitting pieces and the abutting groove, and the extension rod is configured to fix a combined film.

2. The universal film application device according to claim 1, wherein the combined film comprises a release film, a decorative film, and a base film;
wherein the release film, the decorative film, and the base film are detachably connected, the release film is disposed on a first side of the decorative film, the base film is disposed on a second side of the decorative film, and the combined film is centrally positioned on the fixing plate.

3. The universal film application device according to claim 1, wherein a bottom wall of the limiting groove is curved, the limiting groove is matched with the first end of the earphone, and the first end of the earphone is an in-ear portion of the earphone.

4. The universal film application device according to claim 3, wherein the abutting groove is a circular groove, a size of the abutting groove is matched with the second end of the earphone, and the second end of the earphone is one end of a main body of the earphone away from the in-ear portion of the earphone.

5. The universal film application device according to claim 1, wherein the fitting pieces are accommodating holes, the buckling piece is a buckle, and the buckle is capable of engaging with any one of the accommodating holes.

6. The universal film application device according to claim 5, wherein the buckle comprises a fool-proof bump, and the fitting pieces comprise fool-proof holes matched with the fool-proof bump.

7. The universal film application device according to claim 5, wherein the buckle is cross-shaped, the accommodating holes are cross-shaped to match with the buckle, and the accommodating holes are communicated with each other.

8. The universal film application device according to claim 7, wherein the buckle is of an asymmetric structure.

9. The universal film application device according to claim 8, wherein a through hole is defined in a bottom wall of the abutting groove, and the through hole allows an earphone line of the earphone to pass through.

10. The universal film application device according to claim 1, wherein the fitting pieces are longitudinally disposed on the fixing plate, and a distance between any two adjacent fitting pieces is different from a distance between any other two adjacent fitting pieces.

11. The universal film application device according to claim 10, wherein the fitting pieces comprise three fitting pieces, and two of the fitting pieces located in a middle of the fixing plate are close to each other.

12. The universal film application device according to claim 11, wherein a distance between a center of a first fitting piece and a center of a second fitting piece is 1-3 millimeters (mm), and a distance between the center of the second fitting piece and a center of a third fitting piece is 5-12 mm.

13. The universal film application device according to claim 1, wherein a length of any of two ends of a longitudinal section of the extension rod is greater than a length of a middle portion of the longitudinal section of the extension rod, and the combined film is centrally positioned on the extension rod.

14. The universal film application device according to claim 13, wherein a sticking groove is defined in the extension rod.

15. The universal film application device according to claim 1, wherein an opening of the abutting groove faces the limiting structure, and an elastic rubber structure is disposed in the abutting groove.

16. The universal film application device according to claim 15, wherein the elastic rubber structure is a rubber ring.

17. The universal film application device according to claim 16, wherein an inner diameter of the rubber ring is 4.5-7 mm, a height of the rubber ring is 8-12 mm, and a thickness of the rubber ring is 2-5 mm.

18. The universal film application device according to claim 17, wherein the fitting pieces comprise two fitting pieces.

19. The universal film application device according to claim 18, wherein a distance between the two fitting pieces is 5-12 mm.

20. The universal film application device according to claim 1, wherein a distance from a first fitting piece to an outermost edge of the abutting groove is 15-30 mm.
